(19) United States
(12) Patent Application Publication
(10) Pub. No.: US 2026/0260155 A1
(43) Pub. Date: Sep. 3, 2026

(54) SYSTEM AND METHOD FOR CREATING OR VALIDATING A CONFIGURATION BASED ON PHYSICAL AND LOGICAL ARTIFACTS

(71) Applicant: Fluence Energy, LLC, Arlington, VA (US)

(72) Inventors: Thomas Jeffrey Winter, Decatur, GA (US); Brett Lance Galura, Vienna, VA (US)

(73) Assignee: Fluence Energy, LLC, Arlington, VA (US)

(21) Appl. No.: 18/866,433

(22) PCT Filed: Sep. 27, 2024
(86) PCT No.: PCT/US2024/048781

§ 371 Date: Nov. 15, 2024

Related U.S. Application Data
(60) Provisional application No. 63/541,144, filed on Sep. 28, 2023.

(51) Int. Cl. G06N 20/00; H02J 3/00; H02J 103/30

(52) U.S. Cl. CPC G06N 20/00; H02J 3/00; H02J 2103/30

(57) ABSTRACT

A computing device includes a memory, a processor coupled to the memory, and programming in the memory. Execution of the programming by the processor configures the computing device to: accept as inputs a plurality of known configurations of at least one type of physically modular device that includes associated physical artifacts, train a machine learning model to learn types of configurations corresponding to the at least one type of physically modular device based on the inputted plurality of known configurations of the at least one type of physically modular device and the associated physical artifacts, and create at least one valid configuration of a physically modular device when fed a set of physical artifacts of the physically modular device based on the learned types of configurations of the machine learning model.

### CROSS-REFERENCE TO RELATED APPLICATIONS

This application claims priority to U.S. Patent Application No. 63/541,144 filed on Sep. 28, 2023, titled “System and Method for Creating or Validating a Configuration Based on Physical and Logical Artifacts,” the content of which is hereby incorporated by reference in its entirety.

### TECHNICAL FIELD

The present disclosure relates to examples of a configuration design system, and embedded methods, for generating valid configurations of battery energy storage systems and energy provisioning systems.

### BACKGROUND

Battery energy storage systems, compound energy storage systems, as well as energy provisioning systems are often very large installations, with multiple types of components in various housings. These types of components have certain interrelationships, and often have proximity, adjacency, and orientation requirements with respect to other components. To facilitate these systems, the components of the energy provisioning systems tend to be largely modular.

For highly modular components in an energy provisioning system to work as designed, each building block must be connected and interfaced with the rest of the building blocks in the way intended by the designer of the individual building blocks. If the collection of connections and interfaces between modular components is not properly in place, the modular system will miss or limit functionality, or fail to deliver the expected performance. To maximize functionality, the modular energy provisioning system is mapped in a design phase. The mapping of connections and interfaces is commonly referred to as the “configuration.”

Creation of a configuration for a complex system, such as a grid scale energy storage system, which can include thousands of connected devices, is non-trivial. Current processes use some tools for limited automation, such as Excel-based tools, for example, where various project parameters are entered and the basis of a configuration is generated and then modified as needed for use and implementation. However, these tools are cumbersome and prone to error.

Further, once a system has been configured per the planned configuration, it is non-trivial to tell if the configuration plan has been carried out as it was designed. Validation of a configuration is usually a trial-and-error process, where gaps in expected behavior are troubleshot as they are ascertained. Ultimately, complex problems can be very hard to remedy, and some errors may not be found until an energy provisioning system has been under operation and turned over to a service team from a commissioning team.

Hence, there is a need for systems and methods directed to creating and validating a configuration of an energy provisioning system or a battery energy storage system.

### SUMMARY

In a first example, a computing device 403 includes a memory 535, a processor 530 coupled to the memory 535, and programming 330A in the memory 535. Execution of the programming 330A by the processor 530 configures the computing device 403 to accept as inputs a plurality of known configurations 111A-N of at least one type of physically modular device 550 that includes associated physical artifacts 555A-555B, train a machine learning model 340 to learn types of configurations corresponding to the at least one type of physically modular device 550 based on the inputted plurality of known configurations 111A-N of the at least one type of physically modular device 550 and the associated physical artifacts 555A-555B, and create at least one valid configuration 111A-N of a physically modular device 550 when fed a set of physical artifacts 555A-555B of the physically modular device 550 based on the learned types of configurations 111A-N of the machine learning model 340.

In a second example, a method includes determining properties and structure of validated configurations 111A-N of a physically modular device 550, associating the validated configurations 111A-N with a plurality of physical artifacts 555A-555B of the physically modular device 550, and executing a machine learning algorithm including: feeding as inputs examples of known configurations 111A-N of at least one type of physically modular device 550 that includes associated physical artifacts 555A-555B, training a machine learning model 340 to learn types of configurations 111A-N corresponding to the at least one type of physically modular device 550 based on the inputted examples of known configurations 111A-N of the at least one type of physically modular device 550 and the associated physical artifacts 555A-555B, and creating at least one valid configuration 111A-N of a physically modular device 550 when fed a set of physical artifacts 555A-555B of the physically modular device 550 based on the learned types of configurations 111A-N of the machine learning model 340.

In a third example, a non-transitory computer-readable medium 313 includes programming 330A. Execution of the programming 330A by one or more processors 312, 530 configures one or more computing devices 403 to: accept as inputs a plurality of known configurations 111A-N of at least one type of physically modular device 550 that includes associated physical artifacts 116A-N and logical artifacts; train a machine learning model 340 to learn types of configurations 111A-N corresponding to the at least one type of physically modular device 550 based on the inputted plurality of known configurations 111A-N of the at least one type of physically modular device 550 and the associated physical artifacts 116A-N; and create at least one valid configuration 111A-N of a physically modular device 550 when fed a set of physical artifacts 116A-N of the physically modular device 550 based on the learned types of configurations 111A-N of the machine learning model 340.

Additional objects, advantages and novel features of the examples will be set forth in part in the description which follows, and in part will become apparent to those skilled in the art upon examination of the following and the accompanying drawings or may be learned by production or operation of the examples. The objects and advantages of the present subject matter may be realized and attained by means of the methodologies, instrumentalities and combinations particularly pointed out in the appended claims.

### BRIEF DESCRIPTION OF THE DRAWINGS

The drawing figures depict one or more implementations in accordance with the present concepts, by way of example only, not by way of limitations. In the figures, like reference numerals refer to the same or similar elements.

FIG. 1 depicts a system that includes an energy storage system, an energy system, and an electrical application, according to embodiments of the present disclosure.

FIG. 2 illustrates a first energy storage node of a plurality of energy storage nodes of the energy storage system of FIG. 1 coupled to the electrical application.

FIG. 3 is a cutaway view of the first energy storage node of the plurality of energy storage nodes and shows details of a plurality of battery storage elements.

FIG. 4 is a high-level functional block diagram of the energy storage system of FIG. 1 that depicts components of the control system and an example computing device for creating and/or validating configurations of an energy storage system.

FIG. 5 is a diagram of a configuration creation and validation system.

FIG. 6 is a flowchart depicting a method for creating and/or validating configurations of an energy storage system, according to an embodiment.

### PARTS LISTING

100 System
101 Energy Storage System
102 Energy System
103 Electrical Application
104 Power Conversion System
105A-N Energy Storage Nodes
106, 106A-N Battery Storage Elements
107 Power Conversion Subsystem
108 Transformer
109 Energy Source
110 Control Subsystem
111A-N Known Configurations
115 Control System
116A-N Physical Artifacts
117A-N Logical Artifacts
120 Physical Space
125 Power Bus
205 Power Inverter
210 Rectifier
215 DC-DC Converter
300 Enclosure
304 Additional Data
305, 305A-N Network
311, 534 Network Communication Interface
312, 530 Processor
313, 353, 535 Memory
330A-B Control Programming
340 Machine Learning Model
403 User Device
500 Configuration Creation and Validation System
532 User Interface
550 Physically Modular Device
560 Configuration of Physically Modular Device
600 Process Flow

### Detailed Description

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, transfer functions, and/or circuitry have been described at a relatively high-level, without detail, in order to avoid unnecessarily obscuring aspects of the present teachings.

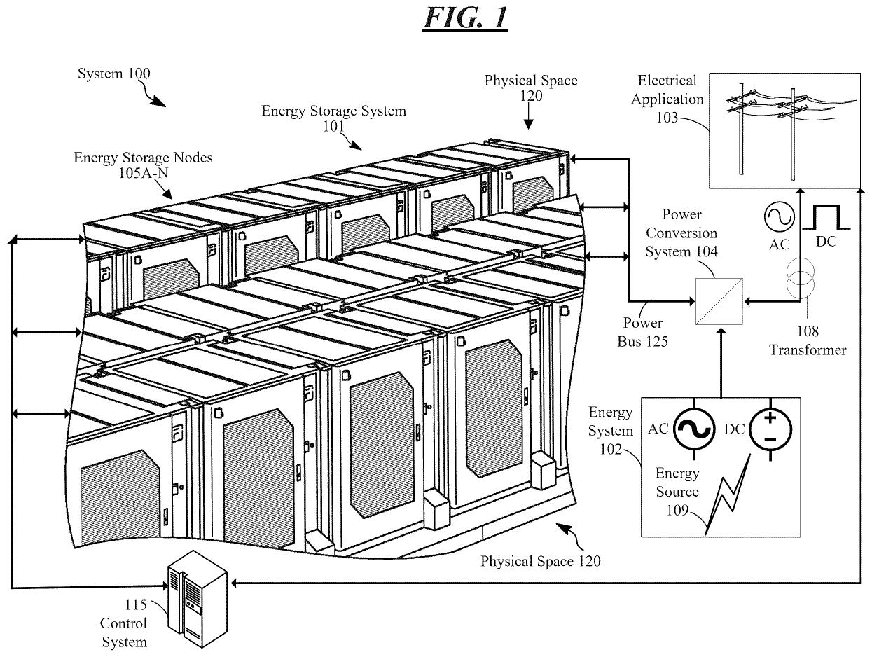

Unless otherwise indicated, any embodiment can be combined with any other embodiment. In particular, FIGS. 1-6 and the associated text are all combinable with each other.

The term “coupled” as used herein refers to any logical, physical, electrical, or optical connection, link or the like by which signals or light produced or supplied by one system element are imparted to another coupled element. Unless described otherwise, coupled elements or devices are not necessarily directly connected to one another and may be separated by intermediate components, elements, or communication media that may modify, manipulate, or carry the light or signals.

The orientations of the system 100, energy storage system 101, energy storage nodes 105A-N, associated components, and/or any complete devices, incorporating battery storage elements 106A-N, such as batteries, such as shown in any of the drawings, are given by way of example only, for illustration and discussion purposes. In operation for a particular energy storage application, an energy storage node 105A-N may be oriented in any other direction suitable to the particular application of the energy storage system 101, for example upright, sideways, or any other orientation. Also, to the extent used herein, any directional term, such as left, right, front, rear, back, end, up, down, upper, lower, top, bottom, and side, are used by way of example only, and are not limiting as to direction or orientation of any energy storage system 101 or energy storage nodes 105A-N; or component of an energy storage system 101 or energy storage nodes 105A-N constructed as otherwise described herein.

Unless otherwise indicated, any multiplicity of components, such as energy storage nodes 105A-N or battery storage elements 106A-N can include any number of said components, including as few as one, and are not limited by the depicted number of components. Unless otherwise indicated, any coupled electrical components can be linked in series or in parallel. In the case of energy storage nodes 105A-N or battery storage elements 106A-N, the components may be linked in series, in parallel, or a combination thereof depending upon a state of a switch or a submodule.

The configuration creation and validation technologies disclosed herein determine the properties and structure of acceptable configurations, and associate these acceptable configurations with artifacts from known configurations conforming with the acceptable configurations. Once determined, the configuration creation and validation technologies can create acceptable configurations based on a novel set of artifacts. Further, the configuration creation and validation technologies disclosed herein can validate the configuration of commissioned energy provisioning system or battery energy storage system based on artifacts of that commissioned system being favorably comparable to a created acceptable configuration using those artifacts.

The configuration creation and validation technologies disclosed herein reduce effort in creating a configuration for a modular device. For example, when delivery teams commission an energy storage system, they must create a configuration mapping for all devices in the equipment and then must configure equipment to that mapping to ensure successful operation. The configuration creation and validation technologies disclosed herein also reduce effort in validating an existing configuration. For example, before completing commissioning and entering energization, commissioning teams must take steps to ensure the configuration is accurate, by determining whether every device that is supposed to be on the network is present; whether there any unexpected devices present on the network; and whether devices that are supposed to talk to one another are able to do so.

Reference now is made in detail to the examples illustrated in the accompanying drawings and discussed below.

FIG. 1 depicts a system 100 that includes an energy storage system 101, energy system 102, and an electrical application 103. For example, the energy storage system 101 can be a battery energy storage system (BESS). The energy storage system 101 is coupled to the energy system 102 and the electrical application 103. Energy storage system 101 can include a power conversion system 104, a plurality of energy storage nodes 105A-N, an optional transformer 108, and a control system 115. Components of the energy storage system 101 can be located at a physical space 120 that is outdoors or indoors, for example, inside of a building, a container, or other structure.

Power conversion system 104 is coupled to the plurality of energy storage nodes 105A-N. The power conversion system 104 is coupled to the energy system 102 and the electrical application 103 to provide a required power flow to the electrical application 103 by discharging the plurality of energy storage nodes 105A-N or the required power flow from the energy system 102 for charging the plurality of energy storage nodes 105A-N. The power conversion system 104 can be coupled to an optional transformer 108. The optional transformer 108 can step up or step down the required power flow to and from the electrical application 103, such as an AC voltage.

Energy system 102 can include any suitable system for producing electrical energy from an energy source 109. Energy system 102 can be a renewable energy system in which the energy source 109 can be replenished. Such a renewable energy source 109 can include solar power, wind power, geothermal power, biomass, and hydroelectric power. For example, the renewable energy system 102 can be implemented as an array of photovoltaic modules. The photovoltaic (PV) modules can include crystalline silicon, amorphous silicon, copper indium gallium selenide (CIGS) thin film, cadmium telluride (CdTe) thin film, and concentrating photovoltaic which uses lenses and curved mirrors to focus sunlight onto small, but highly efficient, multi-junction solar cells. In another example, the energy system 102 can include wind turbines or gas turbines. In some examples, the energy system 102 can be a non-renewable energy system in which the energy source 109 includes a non-renewable energy source, such as a fossil fuel.

Electrical application 103 can include an electrical grid, such as a power grid, or a smaller local load, such as a backup power system, for a facility such as a hospital, manufacturing site, residential home, or other suitable facility. The electrical application 103 may deliver AC or DC power for on-grid or off-grid applications, including commercial, industrial, or residential applications. The electrical application 103 may deliver power to buildings, electric vehicle charging stations, etc., including a variety of electrical loads that consume AC or DC electric power. The electrical application 103 can be a front-of-the-meter system that is owned or operated by a utility company or a behind-the-meter system that directly supplies buildings and homes with electricity.

Energy source 109 can be a renewable energy source, such as solar power and wind power, which can be intermittent and less reliable compared to fossil fuels. To improve resiliency, energy storage system 101 can store energy from the energy system 102 when the production from the energy source 109 is high. Later on, the energy storage system 101 can dispatch the energy to the electrical application 103 when demand is high or production from the energy source 109 is not keeping up with demand. Moreover, events may occur when a connected load or an operating demand load of the electrical application 103 is excessive or there is electrical grid instability, such as during extreme weather. By storing energy from the energy source 109 and then dispatching the energy during such events, the energy storage system 101 can continue to dispatch a required power flow of the electrical application 103.

Energy storage nodes 105A-N include battery storage elements 106A-N. The battery storage elements 106A-N can be: (1) a single battery cell; (2) a cell grouping, including several battery cells in parallel configuration; (3) a battery submodule or module, including several battery cells in parallel and serial configuration; (4) a battery string, including several battery modules in series; (5) a battery bank, including several battery strings in parallel; (6) other known energy storage elements; and/or (7) a combination thereof. For example, the battery storage elements 106A-N can include a plurality of batteries of any existing or future reusable battery technology that can be used in a battery energy storage system (BESS), including, but not limited to, lithium ion or flow batteries, or mechanical storage, such as flywheel energy storage, compressed air energy storage, pumped-storage hydroelectricity, gravitational potential energy, or a hydraulic accumulator, for example.

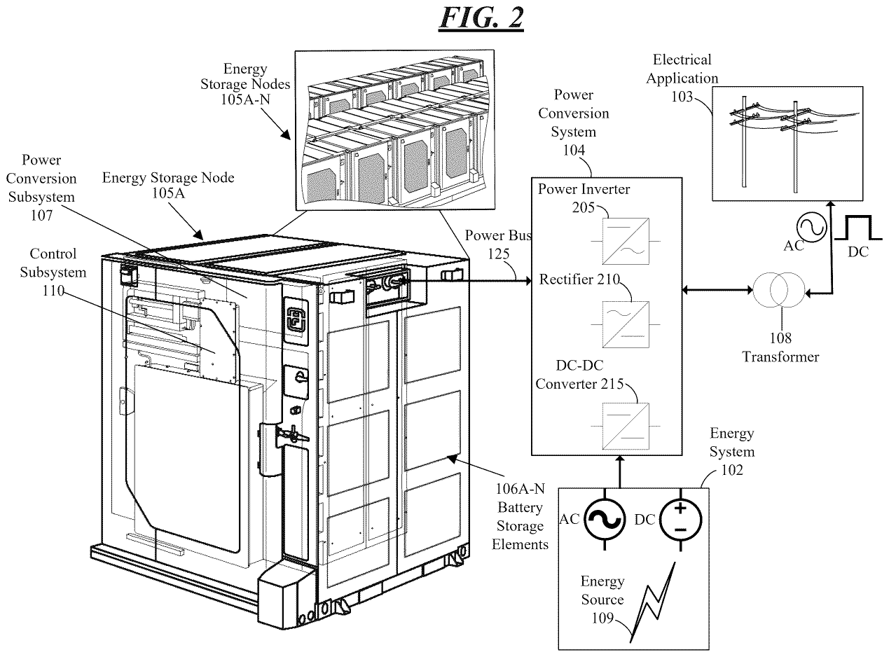

FIG. 2 illustrates a first energy storage node 105A of the plurality of energy storage nodes 105A-N of FIG. 1 coupled to the electrical application 103. Energy storage nodes 105A-N can include a battery storage element 106, a power conversion subsystem 107, and a control subsystem 110, or a combination thereof. Energy storage system 101 can be controlled such that the electrical application 103 is fulfilled while distributing the dispatch of required power flow across the plurality of battery storage elements 106A-N according to awareness of the control system 115 relating to certain battery conditions, including a state of charge, a temperature, and other physical phenomena occurring within the battery storage elements 106A-N.

Power conversion system 104 can include a power inverter 205, a rectifier 210, a DC-DC converter 215, other power conversion elements, or a combination thereof. Power inverter 205 can be configured to convert a DC source, such as from the battery storage elements 106A-N, into an AC waveform. Rectifier 210 can be configured to convert an AC source, such as from the energy system 102 or electrical application 103, into DC for the battery storage elements 106A-N. DC-DC converter 215 can be configured to convert a DC source, such as from the battery storage elements 106A-N, into a different DC source characteristic.

If the energy source 109 is wind power, then the power conversion system 104 can convert the AC electricity produced into DC power for storage in the plurality of energy storage nodes 105A-N via the rectifier 210. If the energy source 109 is solar power, then the power conversion system 104 can convert the DC electricity into a different voltage level via the DC-DC converter 215. The power inverter 205 can convert the required power flow from the energy storage system 101 from DC power into AC power during dispatch to the electrical application 103. For example, the power inverter 205 can be configured to convert power on a power bus 125 for use by the electrical application 103. For example, the power inverter 205 converts DC power stored in the energy storage nodes 105A-N into AC power for consumption by electrical loads of the electrical application 103.

Power conversion subsystem 107 includes similar hardware and software as the more centralized power conversion system 104. Power conversion subsystem 107 is distributed more locally to each of energy storage nodes 105A-N. The control subsystem 110 can be configured for local computation, processing, and control of the battery storage elements 106A-N and the power conversion subsystem 107. The control system 115 can be configured for more centralized computation, processing, and controls of the overall energy storage system 101, energy system 102, electrical application 103, and power conversion system 104. Both the control subsystem 110 and control system 115 can include a single board computer, an application-specific integrated circuit (ASIC), microcontroller, digital signal processor (DSP), field-programmable gate array (FPGA), or a combination thereof.

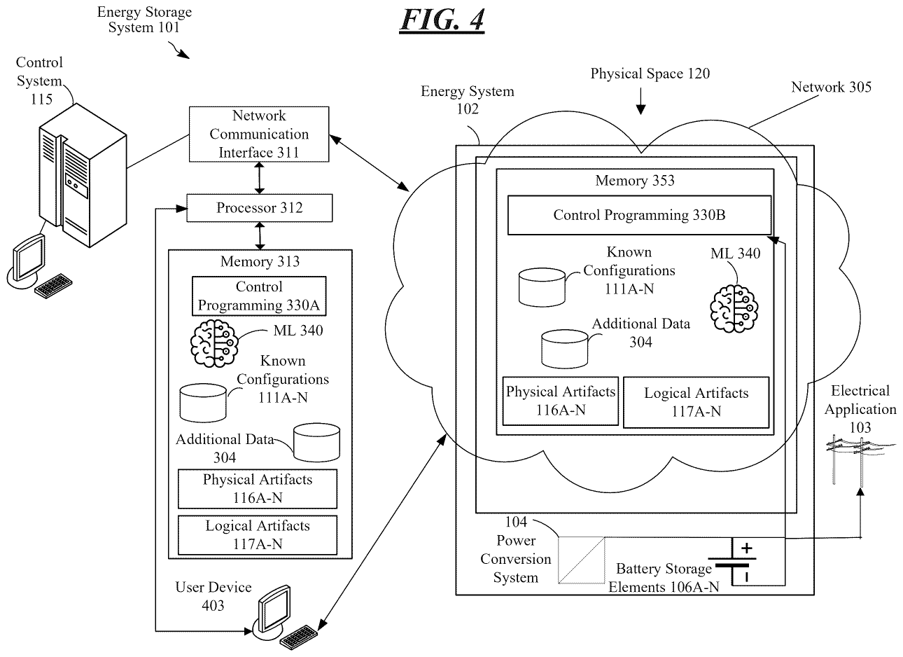

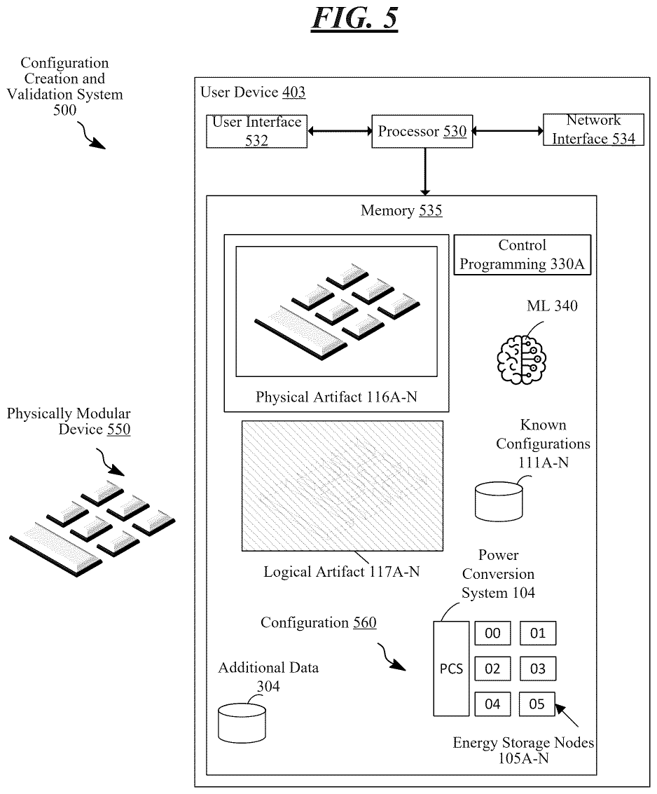

The control system 115 may interface with, or include, a machine learning model 340, (see FIGS. 4 and 5).

Physical data collection sensors and data logging can be used throughout the energy storage system 101, to collect operational and environmental data from the components of the energy storage system 101, such as the energy storage nodes 105A-N, power conversion systems (PCS) 104, battery management systems (BMSs), apparent power system controllers (APSs), node storage dispatch units (SDUs), core SDUs, and real-time automation controllers (RTACs). The collected data can include, but is not limited to, state of charge (SOC), power, differential voltages, or temperature of the energy storage nodes, PCSs, BMSs, APSs, node SDUs, core SDUs, or RTAC.

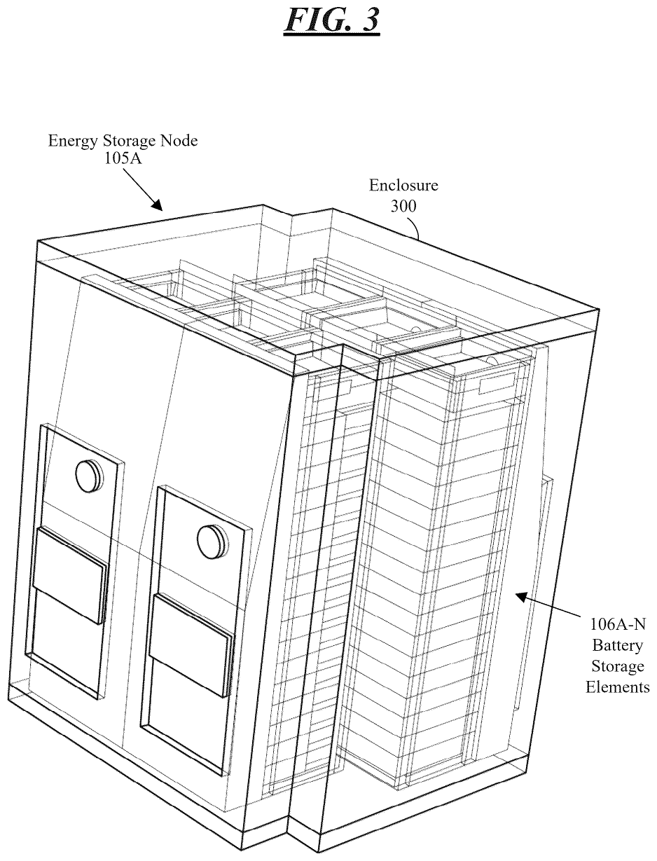

FIG. 3 is a cutaway view of the first energy storage node 105A of the plurality of energy storage nodes 105A-N and shows details of a plurality of battery storage elements 106A-N. As shown, the energy storage node 105A includes an enclosure 300, such as a physical housing to store a plurality of battery storage elements 106A-N. The battery storage elements 106A-N can be a collection of one or more batteries, such as a plurality of battery strings or battery banks, which are organized logically, physically, and electrically.

In the example of FIG. 3, the battery storage elements 106A-N can include battery racks (e.g., six are shown) that hold a respective stack of battery modules (e.g., seventeen are shown). The battery modules can include an array of prismatic, pouch, or cylindrical battery cells that are packaged together to increase voltage, amperage, or both. In some examples, battery modules may include an electric vehicle battery pack, e.g., a collection of lithium-ion battery cells that are packaged together.

The energy storage nodes 105A-N may resemble the features presented in the energy storage system described in International Application No. PCT/US2021/30551, filed on May 4, 2021, titled “Energy Storage System with Removable, Adjustable, and Lightweight Plenums,” the entirety of which is incorporated by reference herein.

FIG. 4 is a high-level functional block diagram of the energy storage system 101 of FIG. 1 that depicts components of the control system 115, the energy system 102, and one or more user device(s) 403 connected to each other via a network 305 to create and/or validate configurations of the energy storage system 101. As shown, the energy system 102 may include one or more energy storage nodes 105A-N each having a battery storage element 106A-N that may deliver power to an electrical application 103 (e.g., a power consumer or grid), or a combination thereof.

The control system 115, energy storage nodes 105A-N, electrical application 103, user device(s) 403, and other components of the system 100 can be in communication over a network 305 or one or more networks 305A-N. The networks 305A-N can be a local area network 305A, wide area network 305B, or a combination thereof. For example, the control system 115 can be coupled via a local area network 305A to the energy storage nodes 105A-N and the electrical application 103. Alternative or additionally, the control system 115 can be coupled via a wide area network 305B to the energy storage nodes 105A-N and electrical application 103. Or the control system 115 can be coupled via a combination of networks 305A-N, such as via a local area network 305A to components of the energy storage system 101, including the energy storage nodes 105A-N, and coupled via a wide area network 305B to the electrical application 103.

The user device 403 may include any type of computing device configured to perform one or more of the aspects described herein (e.g., for creating and/or validating configurations of the energy storage system 101). The user device 403 may include, for example, a computer, a laptop computer, a desktop computer, a mainframe computer, a tablet, a smart phone, a mobile phone, a mobile device, a server device, a client device, an automotive electronics device, an extended reality headset, a smart watch, an Internet of things (IOT) device, or any other type of computing device. In some examples, the user device 403 may be configured to receive data from various sources (e.g., via the network 305) related to the energy system 102.

The user device 403 includes a network communication interface 534 (FIG. 5) configured for wired or wireless communication over the network 305. The user device 403 further includes a memory 535 and a processor 530 coupled to the network communication interface 534 and the memory 535. The memory 535 stores instructions that, when executed by the processor 530, cause the processor 530 to perform one or more of the aspects described herein. As shown, the memory 535 of the user device 403 is configured to store control programming 330A-330B, a machine learning model 340, a plurality of known configurations 111A-N of at least one type of a physically modular device 550, and physical artifacts 116A-N and logical artifacts 117A-N associated with the physically modular device 550.

Control system 115 includes a network communication interface 311 configured for wired or wireless communication over the network 305. The control system 115 further includes a memory 313, and a processor 312 coupled to the network communication interface 311 and the memory 313. As shown, the memory 313 of the control system 115 is configured to store control programming 330A-330B, a machine learning model 340, a plurality of known configurations 111A-N of at least one type of a physically modular device 550 (FIG. 5), and physical artifacts 116A-N and logical artifacts 117A-N associated with the physically modular device 550.

The physically modular device 550 can include, but is not limited to, at least one energy storage system 102 that includes a plurality of energy storage nodes 105A-N coupled to a power conversion system 104, an energy provisioning system, a photovoltaic (“PV”) solar plant, a vehicle charging location, or a residential neighborhood attached to an electrical distribution network.

The known configurations 111A-N of the physically modular device 550 can include, but are not limited to, mapping of connections and interfaces between modular components, such as various energy storage nodes 105A-N (FIGS. 1 and 2) coupled to power conversion system (PCS) 104, for example. The modular components can include, but are not limited to, at least one energy storage node and the power conversion system, a controls cabinet, a PV control system, home battery systems, or a vehicle charging station, for example.

The associated physical artifacts 116A-N of the physically modular device 550 can include, but are not limited to, digital representations, imaging modules, or storage modules of at least one of photographs, video footage, blueprints, or engineering drawings, for example, of the physically modular device 550, that are either originally created in a digital format or are physical objects (e.g., paper, tape, film, etc.) that can be scanned and fed into the machine learning model 340 for image recognition and further processing.

The associated logical artifacts 117A-N of the physically modular device 550 can include, but are not limited to, identifiers (e.g., IP addresses, device names, MAC addresses) of devices on the network connecting the physically modular devices 550. The identifiers of devices can include, but are not limited to, Internet Protocol (“IP”) addresses, device names, or media access control (“MAC”) addresses, for example.

The machine learning model 340 can include a configuration creation engine, for example, that learns, or is trained with, what a valid configuration 111A-N should look like for a certain asset type (e.g., physically modular device 550) by being fed (e.g., as an input) examples of known good configurations 111A-N, as well as physical artifacts 116A-N and/or logical artifacts 117A-N (e.g., photos, video footage, blueprints, engineering drawings, IP address mappings, device names, MAC addresses) of the systems (e.g., physically modular device 550) associated with the known good configurations 111A-N. In the context of the present disclosure, a known good or valid configuration 111A-N is a configuration that, individually or collectively, can achieve the operational intent for a certain asset type (e.g., physically modular device 550). The machine learning model 340 can infer the properties and the structure of a known good or valid configuration 111A-N by being fed examples of known good configurations 111A-N. The machine learning model 340 can be a separate module or part of the control programming 330A-B.

The user device 403 and/or the control system 115 can be configured to receive from the energy system 102, and store in memory 535, 313, or in a separate memory 353 of the energy system 102, additional data 304, such as ping times or traffic logs, for example, from a network of connected physically modular devices 550, for example, via network communication interface 311.

Energy storage nodes 105A-N include a control subsystem 110, battery storage elements 106A-N, and a power conversion subsystem 107. Control subsystem 110 of the energy storage nodes 105A-N can include a separate network communication interface (not shown) configured for wired or wireless communication over the network 305, a separate memory (not shown), and a separate processor (not shown) coupled to the network communication interface and the memory.

As shown in FIG. 4, the memory 313 of the control system 115 and/or separate memory 353 of the energy system 102 can be configured to store control programming 330A-330B, a machine learning model 340, a plurality of known configurations 111A-N of at least one type of physically modular device 550, such as energy storage system 102 that includes a plurality of energy storage nodes 105A-N coupled to a power conversion system 104, for example, and their associated physical artifacts 116A-N and logical artifacts 117A-N.

FIG. 5 is a diagram of a configuration creation and validation system 500. The creation and validation system 500 includes a configuration creation and validation device, such as user device 403, for example, and a physically modular device 550. A user may wish to either understand or validate the configuration 560 of the physically modular device 550. The physically modular device 550 can be, for example, at least one of an energy storage system that includes a plurality of energy storage nodes coupled to a power conversion system, an energy provisioning system, a photovoltaic (“PV”) solar plant, a vehicle charging location, or a residential neighborhood attached to an electrical distribution network.

The configuration creation and validation device 403 includes a processor 530, a memory 535, a user interface 532, and an optional network interface 534. The user interface (UI) 532 can be configured to accept as inputs a plurality of known configurations 111A-N of at least one type of physically modular device 550. The known configurations 111A-N can include, but are not limited to, mapping of connections and interfaces between modular components, such as various energy storage nodes 105A-N (FIGS. 1 and 2) coupled to power conversion system (PCS) 104, for example. The modular components can include, but are not limited to, at least one of at least one energy storage node and the power conversion system, a controls cabinet, a PV control system, home battery systems, or a vehicle charging station, for example.

The physically modular device 550 includes associated physical artifacts 116A-N. The physical artifacts 116A-N can include, but are not limited to, digital representations, imaging modules, or storage modules of at least one of photographs, video footage, blueprints, or engineering drawings, for example, of the physically modular device 550.

The physically modular device 550 includes associated logical artifacts 117A-N, such as identifiers (e.g., IP addresses, device names, MAC addresses) of devices on the network connecting the physically modular devices 550. The identifiers of devices can include, but are not limited to, Internet Protocol (“IP”) addresses, device names, or media access control (“MAC”) addresses, for example.

Alternatively, the plurality of known configurations 111A-N of the at least one type of physically modular device 550 and their associated physical artifacts 116A-N and logical artifacts 117A-N can be stored in the memory 535 of the configuration creation and validation device 403 and/or in memory 313, 353.

The configuration creation and validation device 403 can be further configured to gather additional data from a network of connected physically modular devices 550, for example, via network interface 534. The additional data can include, but is not limited to, ping times or traffic logs, for example.

The configuration creation and validation device 403 can include a configuration creation engine, such as a machine learning model 340, for example, that learns, or is trained with, what a configuration 560 should look like for a certain asset type (e.g., physically modular device 550) by being fed examples of known good configurations 111A-N, as well as physical artifacts 116A-N and/or logical artifacts 117A-N (e.g., photos, video footage, blueprints, engineering drawings, IP address mappings, device names, MAC addresses) of the systems (e.g., physically modular device 550) associated with the known good configurations 111A-N. In the context of the present disclosure, a known good or valid configuration 111A-N is a configuration that, individually or collectively, can achieve the operational intent for a certain asset type (e.g., physically modular device 550). The machine learning model 340 can infer the properties and the structure of a known good or valid configuration 111A-N by being fed examples of known good configurations 111A-N.

Once the machine learning model 340 is trained, it can be used to create predicted good configurations 111A-N when fed the set of physical artifacts 116A-N and logical artifacts 117A-N used in the training. One use of such a trained machine learning model 340 can be the creation of expected good or valid configurations 111A-N of the physically modular device 550 (e.g., to be commissioned) based on the learned types of configurations 111A-N of the machine learning model 340. This creation process can be used to create a new configuration creation from only the physical artifacts 116A-N and/or the logical artifacts 117A-N, highly streamlining the configuration creation process, thereby saving time and effort.

A second use of the trained machine learning model 340 can be the creation of an expected good configuration 111A-N, for purposes of comparing the expected good configuration 111A-N to an existing configuration 560, for example. This comparison can be used to validate the existing configuration 560 of the physically modular device 550 and troubleshoot any issues or errors present in the existing configuration 560, based on the result of the comparison.

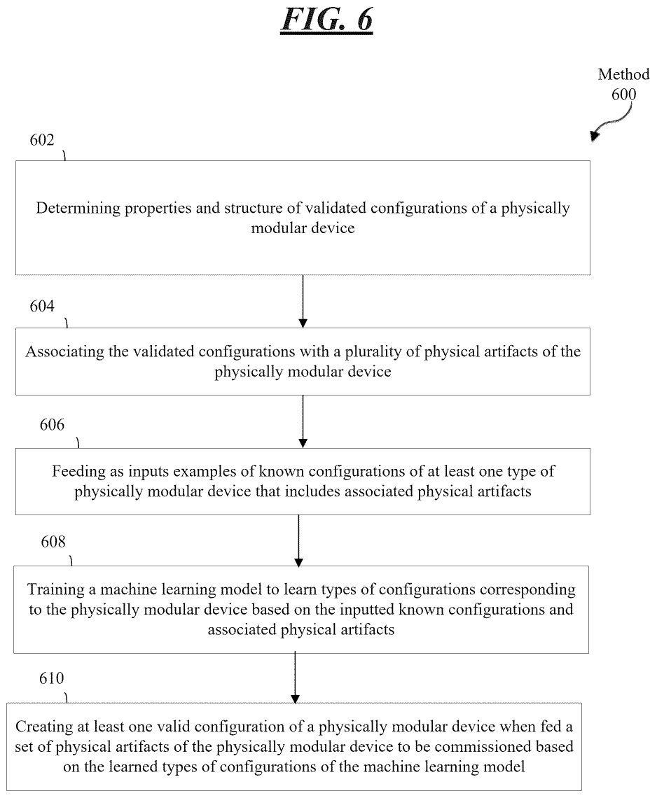

FIG. 6 is a flowchart of a method 600 for creating and/or validating configurations of an energy storage system 101, according to an embodiment.

Beginning in step 602, the method 600 includes determining properties and structure of validated configurations 111A-N of a physically modular device 550 (FIG. 5).

The known configurations 111A-N of the physically modular device 550 can include, but are not limited to, mapping of connections and interfaces between modular components, such as various energy storage nodes 105A-N (FIGS. 1 and 2) coupled to power conversion system (PCS) 104, for example.

Continuing to step 604, the method 600 further includes associating the validated configurations 111A-N with a plurality of physical artifacts 116A-N of the physically modular device 550. The associated physical artifacts 116A-N of the physically modular device 550 can include, but are not limited to, digital representations, imaging modules, or storage modules of at least one of photographs, video footage, blueprints, or engineering drawings, for example, of the physically modular device 550.

Continuing to steps 606-610, the method 600 further includes executing a machine learning algorithm.

In step 606, the machine learning algorithm includes feeding as inputs examples of known configurations 111A-N of at least one type of physically modular device 550 that includes associated physical artifacts 116A-N.

Continuing to step 608, the machine learning algorithm includes training a machine learning model 340 to learn types of configurations corresponding to the at least one type of physically modular device 550 based on the inputted examples of known configurations 111A-N of the at least one type of physically modular device 550 and the associated physical artifacts 116A-N.

Continuing to step 610, the machine learning algorithm includes creating at least one valid configuration 111A-N of a physically modular device 550 when fed a set of physical artifacts 116A-N of the physically modular device 550 based on the learned types of configurations 111A-N of the machine learning model 340.

Although not shown in FIG. 6, the method 600 can further include a step of finding a pattern in the historical operating data 505 from the plurality of energy storage nodes 105A-N that is suitable for feeding an analytic tool.

Although not shown in FIG. 6, the method 600 can further include a step of associating the validated configurations 111A-N with a plurality of logical artifacts 117A-N (e.g., photos, video footage, blueprints, engineering drawings, IP address mappings, device names, MAC addresses) of the physically modular device 550.

Although not shown in FIG. 6, the method 600 can further include a step of feeding as inputs examples of known configurations 111A-N of at least one type of physically modular device 550 that includes the associated physical artifacts 116A-N and the associated logical artifacts 117A-N.

Although not shown in FIG. 6, the method 600 can further include a step of training the machine learning model 340 to learn types of configurations corresponding to the at least one type of physically modular device 550 based on the inputted plurality of known configurations 111A-N of the at least one type of physically modular device 550, the associated physical artifacts 116A-N, and the associated logical artifacts 117A-N.

Although not shown in FIG. 6, the method 600 can further include a step of creating at least one valid configuration 111A-N of the physically modular device 550 when fed the set of physical artifacts 116A-N and a set of logical artifacts 117A-N of the physically modular device 550 based on the learned types of configurations 111A-N of the machine learning model 340.

Although not shown in FIG. 6, the method 600 can further include a step of gathering additional data 304 from a network of connected physically modular devices 550. The additional data 304 can include, for example, ping times or traffic logs from a network of connected physically modular devices 550, via network communication interface 311, for example.

Although not shown in FIG. 6, the method 600 can further include a step of comparing the created at least one valid configuration 111A-N to an existing configuration 111A-N of the physically modular device 550.

Although not shown in FIG. 6, the method 600 can further include a step of validating the existing configuration 111A-N of the physically modular device 550 and troubleshooting any issues or errors present in the existing configuration 111A-N of the physically modular device 550, based on a result of the comparison.

In the examples above, the energy system 102, energy application 103, power conversion system 104, energy storage nodes 105A-N, control subsystem 110, control system 115, user device 403, etc., can each include a processor. As used herein, a processor is a hardware circuit having elements structured and arranged to perform one or more processing functions, typically various data processing functions. Although discrete logic components could be used, the examples utilize components forming a programmable central processing unit (CPU). A processor, for example, includes or is part of one or more integrated circuit (IC) chips incorporating the electronic elements to perform the functions of the CPU. The processors 312, 530, for example, may be based on any known or available microprocessor architecture, such as a Reduced Instruction Set Computing (RISC) using an ARM architecture. Of course, other processor circuitry may be used to form the CPU or processor hardware in. The illustrated examples of the processors 312, 530 can include one microprocessor or a multi-processor architecture. A digital signal processor (DSP) or field-programmable gate array (FPGA) could be suitable replacements for the processors 312, 530, but may consume more power with added complexity.

The applicable processor 312, 530 executes programming or instructions to configure the energy system 102, energy application 103, power conversion system 104, energy storage nodes 105A-N, control subsystem 110, control system 115, user device 403, etc. to perform various operations. For example, such operations may include various general operations (e.g., a clock function, recording and logging operational status and/or failure information) as well as various system-specific operations functions. Although a processor 312, 530 may be configured by use of hardwired logic, typical processors are general processing circuits configured by execution of programming, e.g., instructions and any associated setting data from the memories 313, 353, 535 shown or from other included storage media and/or received from remote storage media.

In the examples above, the energy system 102, energy application 103, power conversion system 104, energy storage nodes 105A-N, control subsystem 110, control system 115, user device 403, etc., each include a memory. The memory 313, 353, 535 may include a flash memory (non-volatile or persistent storage), a read-only memory (ROM), and a random access memory (RAM) (volatile storage). The RAM serves as short term storage for instructions and data being handled by the processors 312, 530, e.g., as a working data processing memory. The flash memory typically provides longer term storage.

Of course, other storage devices or configurations may be added to or substituted for those in the example. Such other storage devices may be implemented using any type of storage medium having computer or processor readable instructions or programming stored therein and may include, for example, any or all of the tangible memory of the computers, processors or the like, or associated modules.

Hence, a machine-readable medium or a computer-readable medium may take many forms of tangible storage medium. Non-volatile storage media include, for example, optical or magnetic disks, such as any of the storage devices in any computer(s) or the like, such as may be used to implement the client device, media gateway, transcoder, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards, paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

According to exemplary embodiments of the present disclosure the one or more processors and control circuits can include one or more of any known general purpose processor or integrated circuit such as a central processing unit (CPU), microprocessor, field programmable gate array (FPGA), Application Specific Integrated Circuit (ASIC), Digital Signal Processor (DSP), or other suitable programmable processing or computing device or circuit as desired that is specially programmed to perform operations for achieving the results of the exemplar embodiments described herein. The processor(s) can be configured to include and perform features of the exemplary embodiments of the present disclosure, such as the control programming 330A-330B and the machine learning model 340, for example. The features can be performed through program code encoded or recorded on the processor(s), or stored in a non-volatile memory device, such as Read-Only Memory (ROM), erasable programmable read-only memory (EPROM), or other suitable memory device or circuit as desired. Accordingly, such computer programs can represent controllers of the computing device.

In another exemplary embodiment, the program code, such as the control programming 330A-330B and the machine learning model 340, for example, can be provided in a computer program product having a non-transitory computer readable medium, such as Magnetic Storage Media (e.g. hard disks, floppy discs, or magnetic tape), optical media (e.g., any type of compact disc (CD), or any type of digital video disc (DVD), or other compatible non-volatile memory device as desired) and downloaded to the processor(s) for execution as desired, when the non-transitory computer readable medium is placed in communicable contact with the processor(s).

The one or more processors 312, 530 can be included in a computing system that is configured with components such as memory, a hard drive, an input/output (I/O) interface, a communication interface, a display and any other suitable component as desired. The exemplary computing device can also include a communications interface. The communications interface can be configured to allow software and data to be transferred between the computing device and external devices. Exemplary communications interfaces can include a modem, a network interface (e.g., an Ethernet card), a communications port, a PCMCIA slot and card, or any other suitable network communication interface as desired.

Software and data transferred via the communications interface can be in the form of signals, which can be electronic, electromagnetic, optical, or other signals as will be apparent to persons having skill in the relevant art. The signals can travel via a communications path, which can be configured to carry the signals and can be implemented using wire, cable, fiber optics, a phone line, a cellular phone link, a radio frequency link, or any other suitable communication link as desired.

Where the present disclosure is implemented using programming or software, including but not limited to the control programming 330A-330B and the machine learning model 340, for example, the programming or software can be stored in a computer program product or non-transitory computer readable medium and loaded into the computing device using a removable storage drive or communications interface. In an exemplary embodiment, any computing device, such as control system 115, control subsystem 110, or user device 403 disclosed herein can also include a display interface that outputs display signals to a display unit, e.g., LCD screen, plasma screen, LED screen, DLP screen, CRT screen, or any other suitable graphical interface as desired.

It will be understood that the terms and expressions used herein have the ordinary meaning as is accorded to such terms and expressions with respect to their corresponding respective areas of inquiry and study except where specific meanings have otherwise been set forth herein. Relational terms such as first and second, or evident and alternative, and the like may be used solely to distinguish one entity or action from another without necessarily requiring or implying any actual such relationship or order between such entities or actions. The terms “comprises,” “comprising,” “includes,” “including,” or any other variation thereof, are intended to cover a non-exclusive inclusion, such that a process, method, article, or apparatus that comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element.

Unless otherwise stated, any and all measurements, values, ratings, positions, magnitudes, sizes, angles, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like may vary by as much as ±5% or as much as ±10% from the stated amount. The terms “approximately” and “substantially” mean that the parameter value or the like varies up to ±10% from the stated amount or position.

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected lies in less than all features of any single disclosed example. Thus, the following claims are hereby incorporated into the Detailed Description, with each claim standing on its own as a separately claimed subject matter.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

1. A computing device, comprising:
a memory;
a processor coupled to the memory; and
programming in the memory, wherein execution of the programming by the processor configures the computing device to:
accept as inputs a plurality of known configurations of at least one type of physically modular device that includes associated physical artifacts;
train a machine learning model to learn types of configurations corresponding to the at least one type of physically modular device based on the inputted plurality of known configurations of the at least one type of physically modular device and the associated physical artifacts; and
create at least one valid configuration of a physically modular device when fed a set of physical artifacts of the physically modular device based on the learned types of configurations of the machine learning model.

2. The computing device of claim 1, wherein the physically modular device further includes associated logical artifacts, and wherein execution of the programming by the processor further configures the computing device to:
train the machine learning model to learn types of configurations corresponding to the at least one type of physically modular device based on the inputted plurality of known configurations of the at least one type of physically modular device, the associated physical artifacts, and the associated logical artifacts; and
create at least one valid configuration of the physically modular device when fed the set of physical artifacts and a set of logical artifacts of the physically modular device based on the learned types of configurations of the machine learning model.

3. The computing device of claim 1, wherein the physically modular device comprises at least one of: an energy storage system that includes a plurality of energy storage nodes coupled to a power conversion system, an energy provisioning system, a photovoltaic (“PV”) solar plant, a charging location, or a residential neighborhood attached to an electrical distribution network.

4. The computing device of claim 3, wherein the known configurations comprise mapping of connections and interfaces between modular components.

5. The computing device of claim 4, wherein the modular components comprise at least one of: at least one energy storage node of the plurality of energy storage nodes and the power conversion system, a controls cabinet, a PV control system, home battery systems, or the charging station.

6. The computing device of claim 1, wherein the physical artifacts comprise digital representations of at least one of: photographs, video footage, blueprints, or engineering drawings of the physically modular device.

7. The computing device of claim 2, wherein the plurality of logical artifacts of the physically modular device comprises identifiers of devices on a network of connected physically modular devices.

8. The computing device of claim 7, wherein the identifiers of devices comprise Internet Protocol (“IP”) addresses, device names, or media access control (“MAC”) addresses.

9. The computing device of claim 1, wherein the computing device is further configured to gather additional data from a network of connected physically modular devices.

10. The computing device of claim 1, wherein the additional data comprises ping times or traffic logs.

11. The computing device of claim 1, wherein the computing device is further configured to compare the created at least one valid configuration to an existing configuration of the physically modular device.

12. The computing device of claim 10, wherein the computing device is further configured to validate the existing configuration of the physically modular device and troubleshoot any issues or errors present in the existing configuration based on a result of the comparison.

13. A method, comprising:
determining properties and structure of validated configurations of a physically modular device;
associating the validated configurations with a plurality of physical artifacts of the physically modular device; and
executing a machine learning algorithm including:
feeding as inputs examples of known configurations of at least one type of physically modular device that includes associated physical artifacts,
training a machine learning model to learn types of configurations corresponding to the at least one type of physically modular device based on the inputted examples of known configurations of the at least one type of physically modular device and the associated physical artifacts, and
creating at least one valid configuration of a physically modular device when fed a set of physical artifacts of the physically modular device based on the learned types of configurations of the machine learning model.

14. The method of claim 13, wherein the physically modular device comprises at least one of: an energy storage system that includes a plurality of energy storage nodes coupled to a power conversion system, an energy provisioning system, a photovoltaic (“PV”) solar plant, a charging location, or a residential neighborhood attached to an electrical distribution network.

15. The method of claim 13, wherein the known configurations comprise mapping of connections and interfaces between modular components.

16. The method of claim 13, wherein the plurality of physical artifacts of the physically modular device comprises digital representations of at least one of: photographs, video footage, blueprints, or engineering drawings of the physically modular device.

17. The method of claim 13, further comprising:
associating the validated configurations with a plurality of logical artifacts of the physically modular device;
feeding as inputs examples of known configurations of at least one type of physically modular device that includes the associated physical artifacts and the associated logical artifacts;
training the machine learning model to learn types of configurations corresponding to the at least one type of physically modular device based on the inputted plurality of known configurations of the at least one type of physically modular device, the associated physical artifacts, and the associated logical artifacts; and
creating at least one valid configuration of the physically modular device when fed the set of physical artifacts and a set of logical artifacts of the physically modular device based on the learned types of configurations of the machine learning model.

18. The method of claim 17, wherein the logical artifacts of the physically modular device comprises identifiers of devices on a network of connected physically modular devices.

19. The method of claim 13, further comprising gathering additional data from a network of connected physically modular devices.

20. The method of claim 19, wherein the additional data gathered from the network of connected physically modular devices comprises ping times or traffic logs.

21.-23. (canceled)
